(19) United States
(12) Patent Application Publication
(10) Pub. No.: US 2022/0261453 A1
(43) Pub. Date: Aug. 18, 2022

(54) Real Estate Search TV Channel

(71) Applicant: Kevin Bilberry, Indian Shores, FL (US)

(72) Inventor: Kevin Bilberry, Indian Shores, FL (US)

(21) Appl. No.: 17/175,621

(22) Filed: Feb. 13, 2021

(51) Int. Cl. G06F 16/9538; G06Q 50/16; G06F 16/909; G06F 16/955; G06F 16/9035; G06F 16/908; H04L 29/06

(52) U.S. Cl. CPC G06F 16/9538; G06Q 50/16; G06F 16/909; H04L 65/4084; G06F 16/9035; G06F 16/908; G06F 16/9558

(57) ABSTRACT

A system, method and computer readable storage media for providing a streaming media television channel for real estate searches provides a streaming media device for providing a television channel for real estate searches. The streaming media device is communicatively interconnected to a streaming media server, and a web server over the Internet. The streaming media device includes a remote-control device, a memory having instructions, and a processor configured to execute the instructions to activate an application in response to a first input command, present an access code on the display device, in response to receiving the access code by the web server entered into a web page associated with the streaming media television channel for real estate searches, connect the streaming media device to the streaming media server to receive the television channel, display the television channel onto the display device, receive a second input command ice, transmit a search query for available properties to the streaming media server in response to the second input command, receive search results in response to the search query. The search results are contained within streaming media data containing video and audio data.

### TECHNICAL FIELD

This application relates in general to a system and method for providing streaming media content, and more specifically, to a system and method for providing searchable real estate listings and locations using streaming media.

### BACKGROUND

Real estate agents face increasing pressure and competition as various Internet search platforms provide potential buyers with a one stop location to perform searches for properties for sale. These competing websites include large and national entities that render the assistance of a local Realtor less important. Additionally, the potential buyers need a compelling presentation of a property to generate interest for the sellers that is typically not available from photographs viewed on a website.

An ideal solution provides potential buyers with an ability to search for and view available properties from the comfort of their couch on a large screen display while providing agents who prepare the viewable content with some level of control to direct potential buyers to their listings before other agents' offerings. Allowing the presentation of a property description to include multimedia content including photos, videos, music, text, and dialog provides agents with an ability to create descriptive content that may generate more interest from the potential buyers.

Therefore, a need exists for a system and method providing searchable real estate listings and locations using streaming media. The present invention attempts to address the deficiencies and limitations of prior solutions according to the principles and example embodiment as disclosed herein.

### SUMMARY

In accordance with the present invention, the above and other problems are solved by providing a system and method for searchable real estate listings and locations using streaming media according to the principles and example embodiments disclosed herein.

In one embodiment, the present invention is a system for providing searchable real estate listings and locations using streaming media. An aspect of the present disclosure provides a streaming media device for providing a streaming media television channel for real estate searches onto a display device. The streaming media device configured to communicatively interconnect the streaming media device, a streaming media server, and a web server over the Internet. The streaming media device includes a remote-control device for receiving input commands from a user, a memory having instructions stored thereon, and a processor configured to execute the instructions on the memory to cause the streaming media device to activate an application on the streaming media device in response to a first input command from the remote-control device, present an access code on the display device, in response to receiving the access code by the web server entered into a web page associated with the streaming media television channel for real estate searches, connect the streaming media device to the streaming media server to receive the streaming media television channel for real estate searches, display the streaming media television channel for real estate searches onto the display device, receive a second input command from the remote control device, transmit a search query for available properties to the streaming media server in response to the second input command, receive search results in response to the search query from the streaming media device, the search results are contained within streaming media data containing streaming video and streaming audio data, and display the search results onto the display device.

In another aspect of the present disclosure, the processor is further configured to execute additional instructions to cause the streaming media device to receive a third input command from the remote-control device, select a property contained within the search results and display property specific information onto the display device, and display the property specific information onto the display device. The property specific information includes a textual description of the property, one or more images of the property, and a message link that sends a prospective buyer message to a real estate agent associated with the streaming media television channel for real estate searches expressing interest in the property in response to a message input command received from the remote-control device activating the message link.

In another aspect of the present disclosure, the property specific information further includes streaming video data of the property, a favorites link that saves an identifier associated with the property to a list of favorite properties associated with a user of the streaming media device in response to a favorites input command received from the remote-control device activating the favorites link, and a map image showing a location of the property.

In another aspect of the present disclosure, the property specific information further includes a forwards link that sends an information message containing a hyperlink associated with the property within a real estate multiple listing service to a specified individual in response to a favorites input command received from the remote-control device activating the favorites link, the information message is sent as a message comprising one of the following: an email and an SMS text message.

In another aspect of the present disclosure, the processor is further configured to execute additional instructions to cause the streaming media device to receive a parameters input command from the streaming media device, the parameters input command specifies one or more search filter parameters applicable to the property, apply the parameters input command to the search results to create filtered search results, and display the filtered search results onto the display device.

In another aspect of the present disclosure, the one or more search filter parameters comprise property type, year built, number of bedrooms, number of bathrooms, minimum square footage, minimum asking price, and maximum asking price.

In another aspect of the present disclosure, contents of the prospective buyer message and the information message are entered by the user using a keyboard displayed on the display device, the contents of the message the prospective buyer message and the information message are specified in a sequence of input character commands received by the streaming media device from the remote-control device selecting characters from the keyboard.

As aspect of the present disclosure provides a method for providing a streaming media television channel for real estate searches onto a display device by a streaming media device, The streaming media device configured to communicatively interconnect the streaming media device, a streaming media server, and a web server over the Internet, the streaming media device comprises a remote-control device for receiving input commands from a user, a memory having instructions stored thereon, and a processor configured to execute the instructions on the memory. The streaming media device includes a remote-control device for receiving input commands from a user, a memory having instructions stored thereon, and a processor configured to execute the instructions on the memory to cause the method to activate an application on the streaming media device in response to a first input command from the remote-control device, present an access code on the display device, in response to receiving the access code by the web server entered into a web page associated with the streaming media television channel for real estate searches, connect the streaming media device to the streaming media server to receive the streaming media television channel for real estate searches, display the streaming media television channel for real estate searches onto the display device, receive a second input command from the remote control device, transmit a search query for available properties to the streaming media server in response to the second input command, receive search results in response to the search query from the streaming media device, the search results are contained within streaming media data containing streaming video and streaming audio data, and display the search results onto the display device.

In another aspect of the present disclosure, the method receives a third input command from the remote-control device, selects a property contained within the search results and display property specific information onto the display device, and displays the property specific information onto the display device. The property specific information includes a textual description of the property, one or more images of the property, and a message link that sends a prospective buyer message to a real estate agent associated with the streaming media television channel for real estate searches expressing interest in the property in response to a message input command received from the remote-control device activating the message link.

Another aspect of the present disclosure the method further receives a parameters input command from the streaming media device, the parameters input command specifies one or more search filter parameters applicable to the property, applies the parameters input command to the search results to create filtered search results, and displaying the filtered search results onto the display device.

An aspect of the present disclosure provides a non-transitory computer-readable recording medium in a streaming media device for providing a streaming media television channel for real estate searches onto a display device by a streaming media device, The streaming media device configured to communicatively interconnect the streaming media device, a streaming media server, and a web server over the Internet, the streaming media device comprises a remote-control device for receiving input commands from a user, a memory having instructions stored thereon, and a processor configured to execute the instructions on the memory. The streaming media device includes a remote-control device for receiving input commands from a user, a memory having instructions stored thereon, and a processor configured to execute the instructions, the non-transitory computer-readable recording medium storing one or more programs which when executed by the processor of the streaming media device performs steps of the methods described above.

The foregoing has outlined rather broadly the features and technical advantages of the present invention in order that the detailed description of the invention that follows may be better understood. Additional features and advantages of the invention will be described hereinafter that form the subject of the claims of the invention.

It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features that are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

Referring now to the drawings in which like reference numbers represent corresponding parts throughout:

FIGS. 1a-b illustrate a system for providing searchable real estate listings and locations using streaming media according to the present invention.

FIG. 2a is a block diagram illustrating an exemplary hardware architecture of a computing device.

FIG. 2b is a block diagram illustrating an exemplary logical architecture for a client device.

FIG. 2c is a block diagram showing an exemplary architectural arrangement of clients, servers, and external services.

FIG. 2d is another block diagram illustrating an exemplary hardware architecture of a computing device.

FIGS. 3a-p illustrate an example embodiment for providing searchable real estate listings and locations using streaming media application screens according to the present invention.

FIG. 4 illustrates an example embodiment of a web page of a system providing searchable real estate listings and locations using streaming media according to the present invention.

FIG. 5 illustrates a computing system of software components of a system providing searchable real estate listings and locations using streaming media according to the present invention.

FIG. 6a-c illustrate a flowchart corresponding to a method performed by software components of a system providing searchable real estate listings and locations using streaming media according to the present invention.

### DETAILED DESCRIPTION

This application relates in general to a system and method for providing streaming media content, and more specifically, to a system and method providing searchable real estate listings and locations using streaming media according to the present invention.

Various embodiments of the present invention will be described in detail with reference to the drawings, wherein like reference numerals represent like parts and assemblies throughout the several views. Reference to various embodiments does not limit the scope of the invention, which is limited only by the scope of the claims attached hereto. Additionally, any examples set forth in this specification are not intended to be limiting and merely set forth some of the many possible embodiments for the claimed invention.

In describing embodiments of the present invention, the following terminology will be used. The singular forms “a,” “an,” and “the” include plural referents unless the context clearly dictates otherwise. Thus, for example, reference to “a needle” includes reference to one or more of such needles and “etching” includes one or more of such steps. As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. As used herein, the singular forms “a,” “an,” and “the” are intended to include the plural forms as well, unless the context clearly indicates otherwise.

It further will be understood that the terms “comprises,” “comprising,” “includes,” and “including” specify the presence of stated features, steps or components, but do not preclude the presence or addition of one or more other features, steps or components. It also should be noted that in some alternative implementations, the functions and acts noted may occur out of the order noted in the figures. For example, two figures shown in succession may in fact be executed substantially concurrently or may sometimes be executed in the reverse order, depending upon the functionality and acts involved.

As used herein, the term “about” means that dimensions, sizes, formulations, parameters, shapes, and other quantities and characteristics are not and need not be exact but may be approximated and/or larger or smaller, as desired, reflecting tolerances, conversion factors, rounding off, measurement error and the like, and other factors known to those of skill. Further, unless otherwise stated, the term “about” shall expressly include “exactly.”

The term “mobile application” refers to an application executing on a mobile device such as a smartphone, tablet, and/or web browser on any computing device.

The terms “potential buyer” and “user” refer to an entity, e.g., a human, using searchable real estate listings and locations using streaming media including any software or smart device application(s) associated with the invention. The term user herein refers to one or more users.

The term “connection” refers to connecting any component as defined below by any means, including but not limited to, a wired connection(s) using any type of wire or cable for example, including but not limited to, coaxial cable(s), fiberoptic cable(s), and ethernet cable(s) or wireless connection(s) using any type of frequency/frequencies or radio wave(s). Some examples are included below in this application.

The term “invention” or “present invention” refers to the invention being applied for via the patent application with the title “Real Estate Search TV Channel.” Invention may be used interchangeably with real estate channel or Realty Stars TV.

The terms “communicate,” or “communication” refer to any component(s) connecting with any other component(s) in any combination for the purpose of the connected components to communicate and/or transfer data to and from any components and/or control any settings.

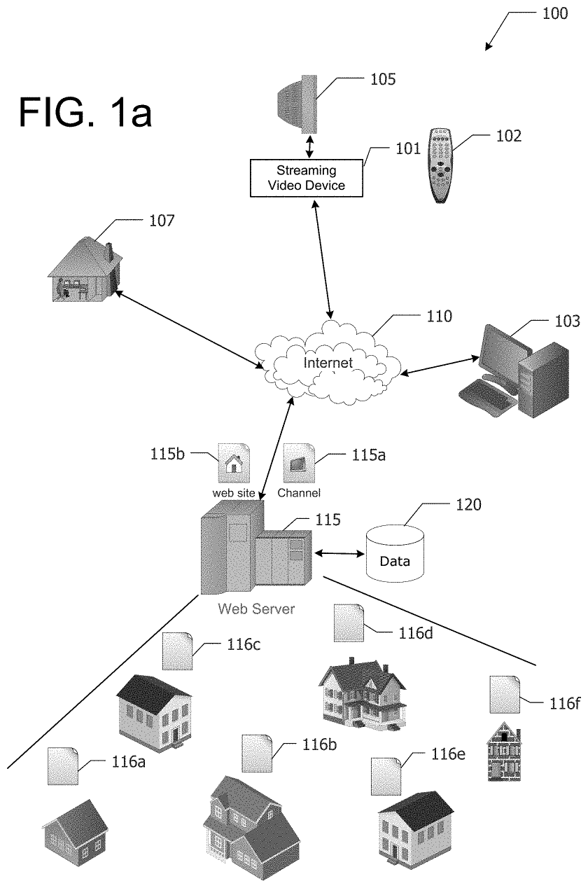

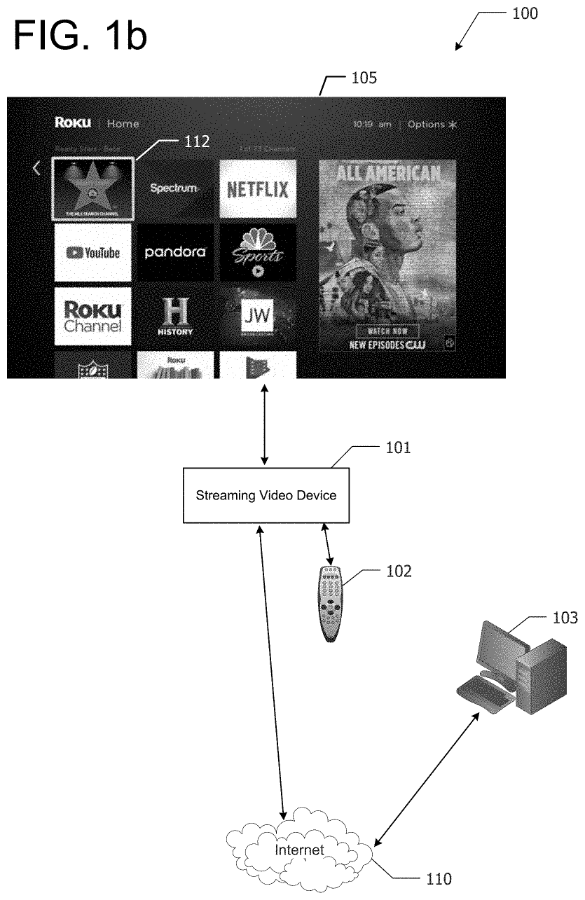

In general, the present disclosure relates to a system and method for providing searchable real estate listings and locations using streaming media. To better understand the present invention, FIG. 1a illustrates a system providing searchable real estate listings and locations using streaming media.

A Realty Stars TV application 100 provides a way for consumers to search real estate properties (MLS data) on their televisions using popular streaming TV devices IOI like Roku™, Amazon Fire TV/Stick™, and Apple TV™. The Realty Stars TV application 100 includes a native application for the Roku™, Amazon Fire™, and Apple TV™ platforms. The product 100 enables individual real estate agents to have their own MLS searchable TV channel on these platforms using a connect method from their websites. Experiences that are currently tailored for viewing on web pages using computing devices such as personal computers, laptops, and tablets may now be viewed on a large screen television 105 from the comfort of a living room. Additionally, navigating the content shown on the real estate channels may be performed using an ordinary television remote device 102. Users may search for properties in various locations that offer properties having specified characteristics. The users may then view the property in photos, videos, textual descriptions and specifications, a map location to learn and discover properties of interest.

The Realty Stars TV application 100 runs on a streaming media device 101 and interacts with a streaming media server 115 to interactively provide the property searching and property viewing activities on a large screen television 103 with simple commands from a television remove device 102. This application 100 eliminates the need for users to connect a computing device to a large screen television 105 and share the computing device's display to search for and view the properties. This simplification is a significant improvement to the experience as the number of connections and set up steps needed is reduced. Additionally, the use of a television remote device 102 in place of interacting with the computing device and viewing the results on the large screen television 105 reduces the devices needs and the complexity of operation of these experiences that results in improved operation of the devices as well as the experience and actions of the users.

FIG. 1b illustrates a system providing searchable real estate listings and locations using streaming media. A potential buyer installs the Realty Stars TV application 100 on his/her streaming media device 101 that is available for use on the large screen television 105. The user selects the Realty Stars TV application icon 112 to activate the application 100 and is provided a code into the streaming media web server 115 of a website 115b of a referring real estate agent 107. The user visits a referring real estate agent's website 115b using a computing device 103 to enter the code provided on the large screen television 105 from the Realty Stars TV application 101. Once that code is entered into the corresponding website 115b, the streaming media server 115 connects the Realty Stars TV application 100 to the referring real estate agent's channel 115a then renders the agent's channel on the potential buyer's large screen television 105. The potential buyer may now search MLS data on their large screen television 105 in a manner controlled by referring real estate agent's channel 115a.

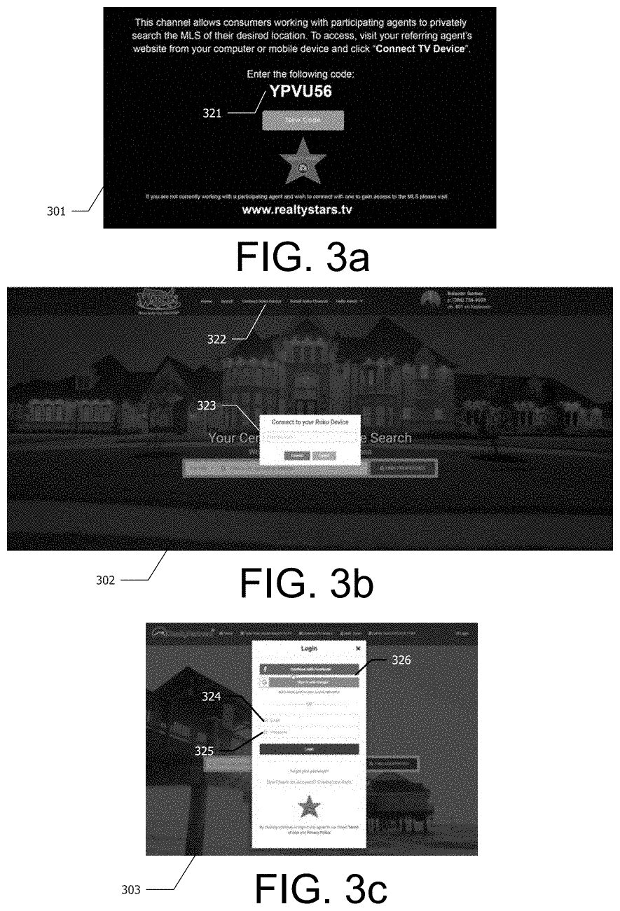

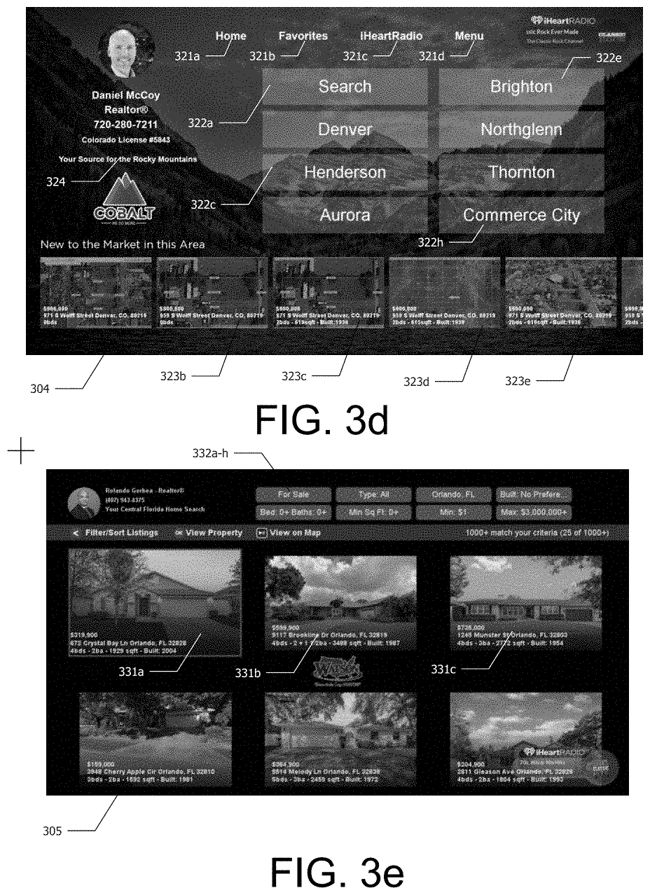

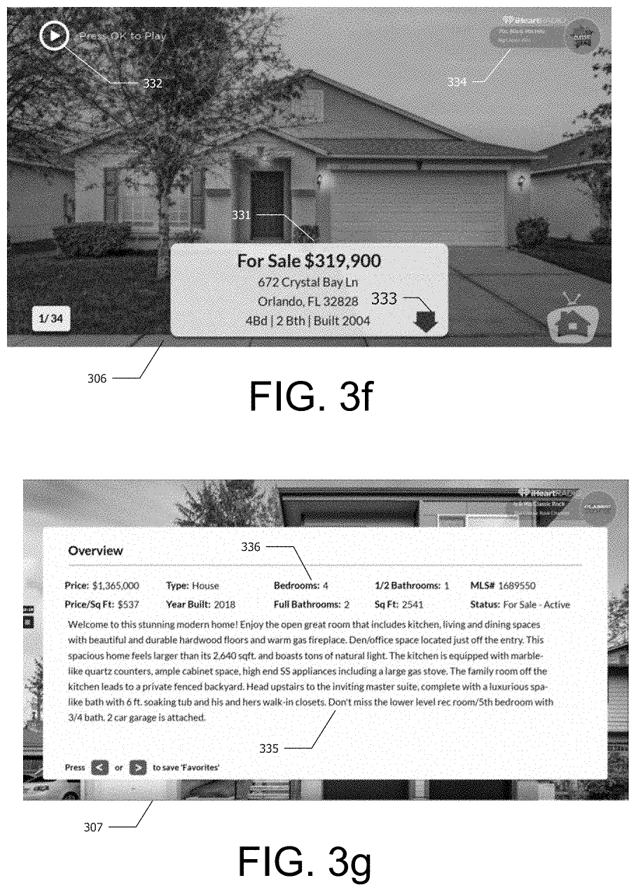

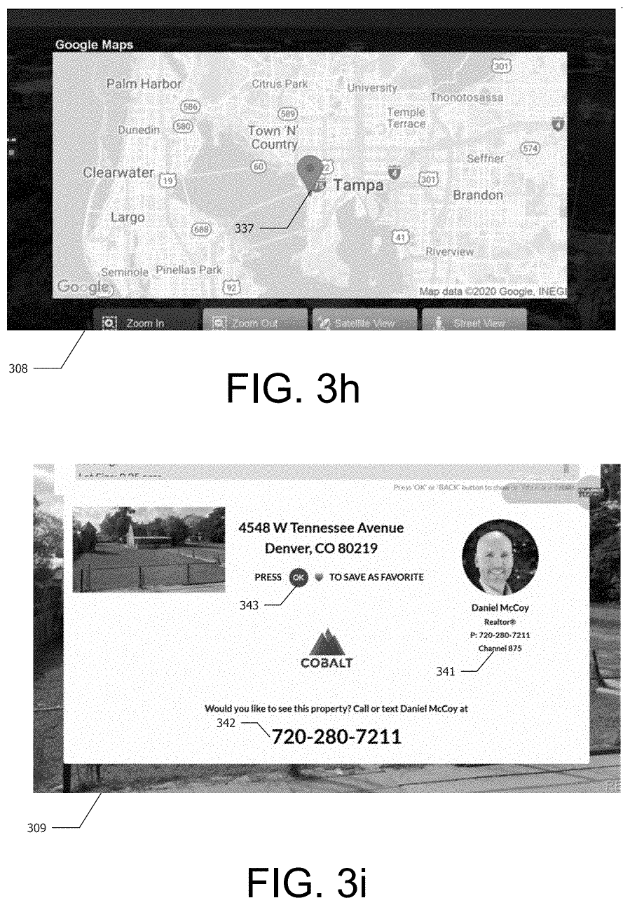

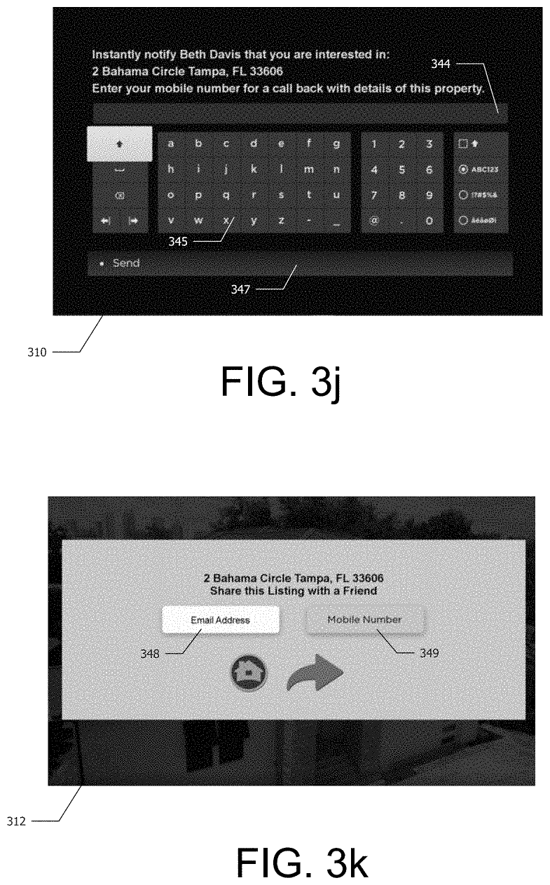

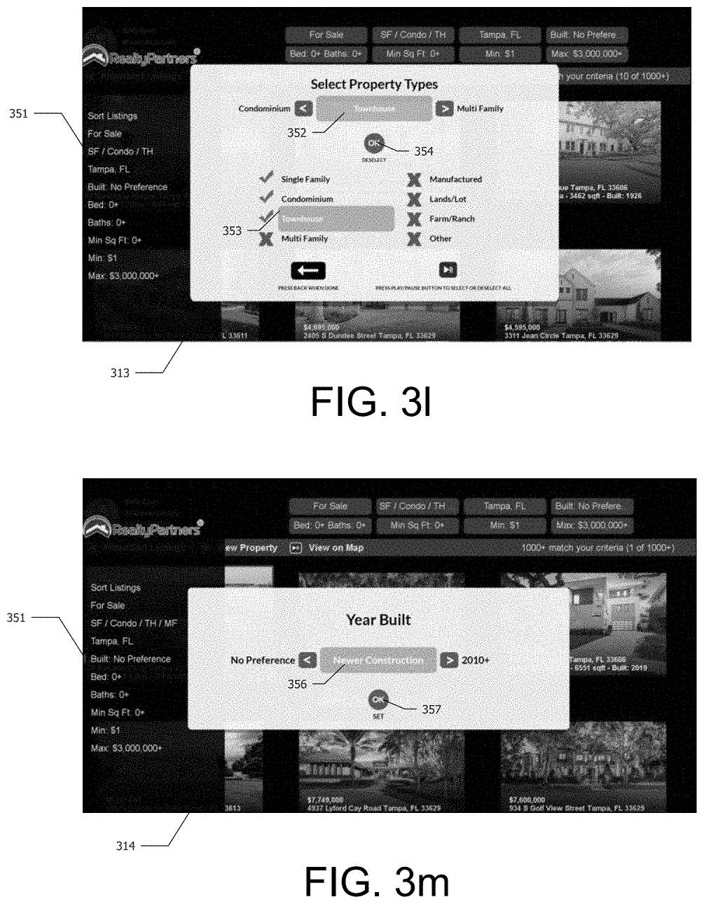

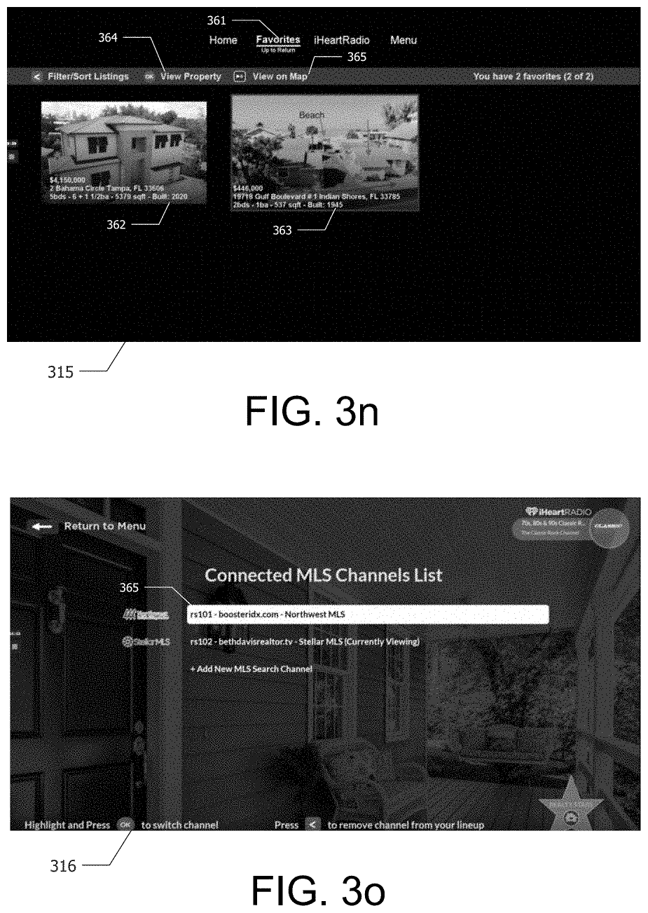

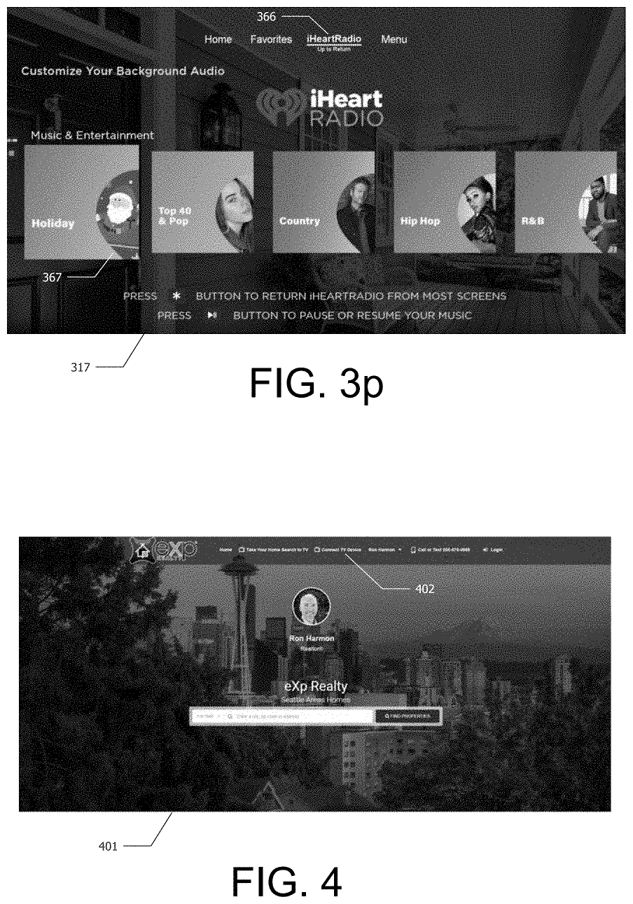

The streaming media web server 115 stores a plurality of streaming media property descriptions 116a-n onto a streaming media data storage 120 attached to the streaming media web server 115 that are rendered into content provided to the streaming media device 101. The Realty Stars TV application 100 running on the streaming media device 101 provides a mechanism to search for available properties in the MLS listings and to render representations of the properties into streaming media content for viewing using the streaming media device 101. The real estate agent 107 may present their listings at the top of any search results as well as provide compelling content that has been created for viewing on a television channel before providing listing of properties offered by other agents that may consist of a simple slide show of photographs and written text. The referring real estate agent's website 115b may also be hosted on the streaming media server 115. In cases in which the referring real estate agent's website 115b is hosted on another platform, the entry of the code by the user into the website 115a is sent to the streaming media server 115 for use. The code identifies the streaming media device 101 of the user by is network address, such as its IP address, that the streaming media server 115 used to provide the code. Using this information, the streaming media server 115 now knows the network address for the streaming media device 101 and the real estate agent channel 115b from the identity of the referring agent's website 115b to be able to start the display of the real estate agent's television channel 115a onto the user's large screen television 105 via the streaming media device 101. The usage of the real estate agent's television channel 115a by the user of the streaming media device 101 is disclosed in more detail in reference to the screen images of FIGS. 3a-p discussed below.

The invention may use any type of network such as a single network, multiple networks of a same type, or multiple networks of different types which may include one or more of a direct connection between devices, including but not limited to a local area network (LAN), a wide area network (WAN) (for example, the Internet), a metropolitan area network (MAN), a wireless network (for example, a general packet radio service (GPRS) network), a long term evolution (LTE) network, a telephone network (for example, a Public Switched Telephone Network or a cellular network), a subset of the Internet, an ad hoc network, a fiber optic network (for example, a fiber optic service (often known as FiOS) network), or any combination of the above networks.

Smart devices mentioned herein the present application may also use one or more sensors to receive or send signals, such as wireless signals for example, Bluetooth™, wireless fidelity, infrared, Wi-Fi, or LTE. Any smart device mentioned in this application may be connected to any other component or smart device via wired communications (e.g., conductive wire, coaxial cable, fiber optic cable, ethernet cable, twisted pair cable, transmission line, waveguide, etc.), or a combination of wired and wireless communications. The invention's method and/or system may use a single server device or a collection of multiple server devices and/or computer systems.

The systems and methods described above may be implemented in many different forms of applications, software, firmware, and hardware. The actual software or smart device application codes or specialized control software, hardware or smart device application(s) used to implement the invention's systems and methods is not limiting of the implementation. Thus, the operation and behavior of the systems and methods were described without reference to the specific software or firmware code. Software, smart device application(s), firmware, and control hardware can be designed to implement the systems and methods based on the description herein.

While all of the above functions are described to be provided to users via a mobile application on a smartphone, one of ordinary skill will recognize that any computing device including tablets, laptops, and general-purpose computing devices may be used as well. In at least one embodiment, all of the services described herein are provided using web pages being accessed from the web server 201 using a web browser such as Safari™, Firefox™, Chrome™ DuckDuckGo™, and the like. All of the screen examples described herein show user interface elements that provide the functionality of the present invention. The arrangement, organization, presentation, and use of particular user input/output (I/O) elements including hyperlinks, buttons, text fields, scrolling lists, and similar I/O elements are shown herein for example embodiments only to more easily convey the features of the present invention. The scope of the present invention should not be interpreted as being limited by any of these elements unless expressly recited within the attached claims.

For the purposes of the example embodiment of FIG. 1, various functions are shown to be performed on different programmable computing devices that communicate with each other over the Internet 105. These computing devices may include smartphones 101a, laptop computers 101b, tablets (not shown), and similar devices so long as the disclosed functionality of the mobile application described herein is supported by the particular computing device. One of ordinary skill will recognize that this functionality is grouped as shown in the embodiment for clarity of description. Two or more of the processing functions may be combined onto a single processing machine. Additionally, it may be possible to move a subset of processing from one of the processing systems shown here and retain the functionality of the present invention. The attached claims recite any required combination of functionality onto a single machine, if required, and all example embodiments are for descriptive purposes.

For all of the above devices that are in communication with each other, some or all of them need not be in continuous communication with each other, unless expressly specified otherwise. In addition, devices that are in communication with each other may communicate directly or indirectly through one or more communication means or intermediaries, logical or physical.

A description of an aspect with several components in communication with each other does not imply that all such components are required. To the contrary, a variety of optional components may be described to illustrate a wide variety of possible aspects, and in order to more fully illustrate one or more aspects. Similarly, although process steps, method steps, algorithms or the like may be described in a sequential order, such processes, methods, and algorithms may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the aspects, and does not imply that the illustrated process is preferred. Also, steps are generally described once per aspect, but this does not mean they must occur once, or that they may only occur once each time a process, method or algorithm is carried out or executed. Some steps may be omitted in some aspect or some occurrences, or some steps may be executed more than once in a given aspect or occurrence.

When a single device or article is described herein, it will be readily apparent that more than one device or article may be used in place of a single device or article. Similarly, where more than one device or article is described herein, it will be readily apparent that a single device or article may be used in place of the more than one device or article.

The functionality or the features of a device may be alternatively embodied by one or more other devices that are not explicitly described as having such functionality or features. Thus, other aspects need not include the device itself

Techniques and mechanisms described or referenced herein will sometimes be described in singular form for clarity. However, it should be appreciated that particular aspects may include multiple iterations of a technique or multiple instantiations of a mechanism unless noted otherwise. Process descriptions or blocks in figures should be understood as representing modules, segments or portions of code which include one or more executable instructions for implementing specific logical functions or steps in the process. Alternate implementations are included within the scope of various aspects in which, for example, functions may be executed out of order from that shown or discussed, including substantially concurrently or in reverse order, depending on the functionality involved, as would be understood by those having ordinary skill in the art.

Generally, the techniques disclosed herein may be implemented on hardware or a combination of software and hardware. For example, they may be implemented in an operating system kernel, in a separate user process, in a library package bound into network applications, on a specially constructed machine, on an application-specific integrated circuit (ASIC), or on a network interface card.

Software/hardware hybrid implementations of at least some of the aspects disclosed herein may be implemented on a programmable network-resident machine (which should be understood to include intermittently connected network-aware machines) selectively activated or reconfigured by a computer program stored in memory. Such network devices may have multiple network interfaces that may be configured or designed to utilize different types of network communication protocols. A general architecture for some of these machines may be described herein in order to illustrate one or more exemplary means by which a given unit of functionality may be implemented. According to specific aspects, at least some of the features or functionalities of the various aspects disclosed herein may be implemented on one or more general-purpose computers associated with one or more networks, such as for example, an end-user computer system, a client computer, a network server or other server system, a mobile computing device (e.g., tablet computing device, mobile phone, smartphone, laptop or other appropriate computing device), a consumer electronic device, a music player or any other suitable electronic device, router, switch or other suitable device, or any combination thereof. In at least some aspects, at least some of the features or functionalities of the various aspects disclosed herein may be implemented in one or more virtualized computing environments (e.g., network computing clouds, virtual machines hosted on one or more physical computing machines or other appropriate virtual environments).

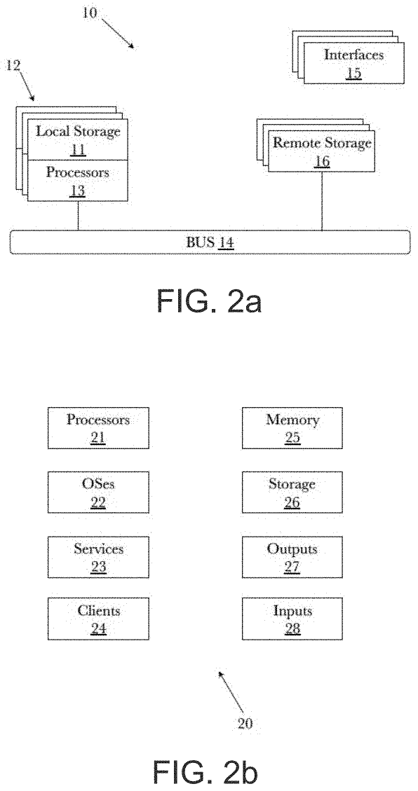

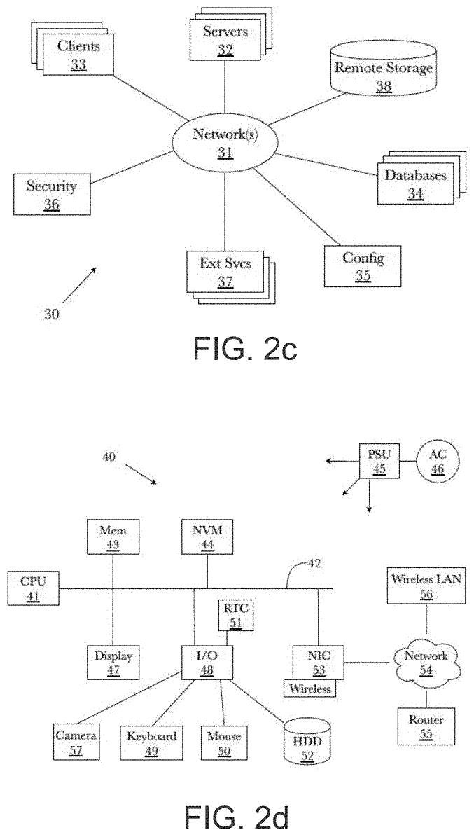

Referring now to FIG. 2a, there is a block diagram depicting an exemplary computing device 10 suitable for implementing at least a portion of the features or functionalities disclosed herein. The computing device 10 may be, for example, any one of the computing machines listed in the previous paragraph, or indeed any other electronic device capable of executing software- or hardware-based instructions according to one or more programs stored in memory. The computing device 10 may be configured to communicate with a plurality of other computing devices, such as clients or servers, over communications networks such as a wide area network, a metropolitan area network, a local area network, a wireless network, the Internet or any other network, using known protocols for such communication, whether wireless or wired.

In one aspect, the computing device 10 includes one or more central processing units (CPUs) 12, one or more interfaces 15, and one or more buses 14 (such as a peripheral component interconnect (PCI) bus). When acting under the control of appropriate software or firmware, the CPU 12 may be responsible for implementing specific functions associated with the functions of a specifically configured computing device or machine. For example, in at least one aspect, a computing device 10 may be configured or designed to function as a server system utilizing a CPU 12, local memory 11 and/or remote memory 16, and interface(s) 15. In at least one aspect, a CPU 12 may be caused to perform one or more of the different types of functions and/or operations under the control of software modules or components, which for example, may include an operating system and any appropriate applications software, drivers, and the like.

A CPU 12 may include one or more processors 13 such as for example, a processor from one of the Intel, ARM, Qualcomm, and AMD families of microprocessors. In some aspect, processors 13 may include specially designed hardware such as application-specific integrated circuits (ASICs), electrically erasable programmable read-only memories (EEPROMs), field-programmable gate arrays (FPGAs), and so forth, for controlling operations of a computing device 10. In a particular aspect, a local memory 11 (such as non-volatile random access memory (RAM) and/or read-only memory (ROM), including for example, one or more levels of cached memory) may also form part of a CPU 12. However, there are many different ways in which memory may be coupled to a system 10. Memory 11 may be used for a variety of purposes such as, for example, caching and/or storing data, programming instructions, and the like. It should be further appreciated that a CPU 12 may be one of a variety of system-on-a-chip-(SOC) type hardware that may include additional hardware such as memory or graphics processing chips, such as a QUALCOMM SNAPDRAGON™ or SAMSUNG EXYNOS™ CPU as are becoming increasingly common in the art, such as for use in mobile devices or integrated devices.

As used herein, the term “processor” is not limited merely to those integrated circuits referred to in the art as a processor, a mobile processor, or a microprocessor, but broadly refers to a microcontroller, a microcomputer, a programmable logic controller, an application-specific integrated circuit, and any other programmable circuit.

In one aspect, interfaces 15 are provided as network interface cards (NICs). Generally, NICs control the sending and receiving of data packets over a computer network; other types of interfaces 15 may, for example, support other peripherals used with a computing device 10. Among the interfaces that may be provided are ethernet interfaces, frame relay interfaces, cable interfaces, DSL interfaces, token ring interfaces, graphics interfaces, and the like. In addition, various types of interfaces may be provided such as, for example, universal serial bus (USB), serial, Ethernet, FIREWIRE™, THUNDERBOLT™, PCI, parallel, radio frequency (RF), BLUETOOTH™, near-field communications (e.g., using near-field magnetics), 802.11 (WiFi), frame relay, TCP/IP, ISDN, fast ethernet interfaces, gigabit ethernet interfaces, serial ATA (SATA) or external SATA (ESATA) interfaces, high-definition multimedia interfaces (HDMI), digital visual interfaces (DVI), analog or digital audio interfaces, asynchronous transfer mode (ATM) interfaces, high-speed serial interfaces (HSSI), point of sale (POS) interfaces, fiber data distributed interfaces (FDDis), and the like. Generally, such interfaces 15 may include physical ports appropriate for communication with appropriate media. In some cases, they may also include an independent processor (such as a dedicated audio or video processor, as is common in the art for high-fidelity A/V hardware interfaces) and, in some instances, volatile and/or non-volatile memory (e.g., RAM).

Although the system shown in FIG. 2a illustrates one specific architecture for a computing device 10 for implementing one or more of the aspects described herein, it is by no means the only device architecture on which at least a portion of the features and techniques described herein may be implemented. For example, architectures having one or any number of processors 13 may be used, and such processors 13 may be present in a single device or distributed among any number of devices. In one aspect, a single processor 13 handles communications as well as routing computations, while in other aspects a separate dedicated communications processor may be provided. In various aspects, different types of features or functionalities may be implemented in a system according to the aspect that includes a client device (such as a tablet device or smartphone running client software) and a server system (such as a server system described in more detail below).

Regardless of network device configuration, the system of an aspect may employ one or more memories or memory modules (for example, remote memory block 16 and local memory 11) configured to store data, program instructions for the general-purpose network operations or other information relating to the functionality of the aspects described herein (or any combinations of the above). Program instructions may control execution of or comprise an operating system and/or one or more applications, for example. Memory 16 or memories 11, 16 may also be configured to store data structures, configuration data, encryption data, historical system operations information or any other specific or generic non-program information described herein.

Because such information and program instructions may be employed to implement one or more systems or methods described herein, at least some network device aspects may include non-transitory machine-readable storage media, which, for example, may be configured or designed to store program instructions, state information, and the like for performing various operations described herein. Examples of such non-transitory machine-readable storage media include, but are not limited to, magnetic media such as hard disks, floppy disks, and magnetic tape; optical media such as CD-ROM disks; magneto-optical media such as optical disks, and hardware devices that are specially configured to store and perform program instructions, such as read-only memory devices (ROM), flash memory (as is common in mobile devices and integrated systems), solid state drives (SSD) and “hybrid SSD” storage drives that may combine physical components of solid state and hard disk drives in a single hardware device (as are becoming increasingly common in the art with regard to personal computers), memristor memory, random access memory (RAM), and the like. It should be appreciated that such storage means may be integral and non-removable (such as RAM hardware modules that may be soldered onto a motherboard or otherwise integrated into an electronic device) or they may be removable such as swappable flash memory modules (such as “thumb drives” or other removable media designed for rapidly exchanging physical storage devices), “hot-swappable” hard disk drives or solid state drives, removable optical storage disks, or other such removable media, and that such integral and removable storage media may be utilized interchangeably. Examples of program instructions include both object code, such as may be produced by a compiler, machine code, such as may be produced by an assembler or a linker, byte code, such as may be generated by for example by a JAVA™ compiler and may be executed using a JAVA™ virtual machine or equivalent, or files containing higher level code that may be executed by the computer using an interpreter (for example, scripts written in Python™, Perl™, Ruby™, Groovy™, or any other scripting language).

In some aspects, systems may be implemented on a standalone computing system. Referring now to FIG. 2b, there is a block diagram depicting a typical exemplary architecture of one or more aspects or components thereof on a standalone computing system. A computing device 20 includes processors 21 that may run software that carry out one or more functions or applications of aspects, such as for example a client application 24. Processors 21 may carry out computing instructions under control of an operating system 22 such as, for example, a version of MICROSOFT WINDOWS™ operating system, APPLE macOS™ or iOS™ operating systems, some variety of the LINUX™ operating system, ANDROID™ operating system, or the like. In many cases, one or more shared services 23 may be operable in system 20, and may be useful for providing common services to client applications 24. Services 23 may, for example, be WINDOWS™ services, user-space common services in a LINUX™ environment or any other type of common service architecture used with an operating system 22. Input devices 28 may be of any type suitable for receiving user input including, for example, a keyboard, touchscreen, microphone (for example, for voice input), mouse, touchpad, trackball or any combination thereof. Output devices 27 may be of any type suitable for providing output to one or more users, whether remote or local to system 20, and may include, for example, one or more screens for visual output, speakers, printers or any combination thereof. Memory 25 may be RAM having any structure and architecture known in the art for use by processors 21, for example to run software. Storage devices 26 may be any magnetic, optical, mechanical, memristor or electrical storage device for storage of data in digital form (such as those described above, referring to FIG. 2a). Examples of storage devices 26 include flash memory, magnetic hard drive, CD-ROM, and the like.

In some aspects, systems may be implemented on a distributed computing network, such as one having any number of clients and/or servers. Referring now to FIG. 2c, there is a block diagram depicting an exemplary architecture 30 for implementing at least a portion of a system according to one aspect on a distributed computing network. According to the aspect, any number of clients 33 may be provided. Each client 33 may run software for implementing client-side portions of a system; clients may comprise a system 20 such as that illustrated in FIG. 2b. In addition, any number of servers 32 may be provided for handling requests received from one or more clients 33. Clients 33 and servers 32 may communicate with one another via one or more electronic networks 31, which may be in various aspects any Internet, wide area network, mobile telephony network (such as CDMA or GSM cellular networks), wireless network (such as WiFi, WiMAX, LTE, and so forth) or local area network (or indeed any network topology known in the art; the aspect does not prefer any one network topology over another). Networks 31 may be implemented using any known network protocols, including, for example, wired and/or wireless protocols.

In addition, in some aspects, servers 32 may call external services 37 when needed to obtain additional information, or to refer to additional data concerning a particular call. Communications with external services 37 may take place, for example, via one or more networks 31. In various aspects, external services 37 may comprise web-enabled services or functionality related to or installed on the hardware device itself For example, in one aspect where client applications 24 are implemented on a smartphone or other electronic device, client applications 24 may obtain information stored on a server system 32 in the Cloud or on an external service 37 deployed on one or more of a particular enterprise's or user's premises. In addition to local storage on servers 32, remote storage 38 may be accessible through the network(s) 31.

In some aspects, clients 33 or servers 32 (or both) may make use of one or more specialized services or appliances that may be deployed locally or remotely across one or more networks 31. For example, one or more databases 34 in either local or remote storage 38 may be used or referred to by one or more aspects. It should be understood by one having ordinary skill in the art that databases in storage 34 may be arranged in a wide variety of architectures and use a wide variety of data access and manipulation means. For example, in various aspects one or more databases in storage 34 may comprise a relational database system using a structured query language (SQL), while others may comprise an alternative data storage technology such as those referred to in the art as “NoSQL” (for example, HADOOP CASSANDRA™, GOOGLE BIGTABLE™, and so forth). In some aspects, variant database architectures such as column-oriented databases, in-memory databases, clustered databases, distributed databases, or even flat file data repositories may be used according to the aspect. It will be appreciated by one having ordinary skill in the art that any combination of known or future database technologies may be used as appropriate, unless a specific database technology or a specific arrangement of components is specified for a particular aspect described herein. Moreover, it should be appreciated that the term “database” as used herein may refer to a physical database machine, a cluster of machines acting as a single database system or a logical database within an overall database management system. Unless a specific meaning is specified for a given use of the term “database,” it should be construed to mean any of these senses of the word, all of which are understood as a plain meaning of the term “database” by those having ordinary skill in the art.

Similarly, some aspects may make use of one or more security systems 36 and configuration systems 35. Security and configuration management are common information technology (IT) and web functions, and some amount of each are generally associated with any IT or web system. It should be understood by one having ordinary skill in the art that any configuration or security subsystems known in the art now or in the future may be used in conjunction with aspects without limitation, unless a specific security 36 or configuration system 35 or approach is required by the description of any specific aspect.

FIG. 2d shows an exemplary overview of a computer system 40 as may be used in any of the various locations throughout the system. It is exemplary of any computer that may execute code to process data. Various modifications and changes may be made to a computer system 40 without departing from the broader scope of the system and method disclosed herein. A CPU 41 is connected to bus 42, to which bus is also connected to memory 43, non-volatile memory 44, display 47, I/O unit 48, and network interface card (NIC) 53. An I/O unit 48 may, typically, be connected to peripherals such as a keyboard 49, pointing device 50, hard disk 52, real-time clock 51, camera 57, and other peripheral devices. A NIC 53 connects to a network 54, which may be the Internet or a local network, which local network may or may not have connections to the Internet. The system may be connected to other computing devices through the network via a router 55, wireless local area network 56 or any other network connection. Also shown as part of a system 40 is a power supply unit 45 connected, in this example, to a main alternating current (AC) supply 46. Not shown are batteries that could be present and many other devices and modifications that are well known, but are not applicable to, the specific novel functions of the current system and method disclosed herein. It should be appreciated that some or all components illustrated may be combined, such as in various integrated applications, for example Qualcomm or Samsung system-on-a-chip (SOC) devices, or whenever it may be appropriate to combine multiple capabilities or functions into a single hardware device (for instance, in mobile devices such as smartphones, video game consoles, in-vehicle computer systems such as navigation or multimedia systems in automobiles or other integrated hardware devices).

In various aspects, functionality for implementing systems or methods of various aspects may be distributed among any number of client and/or server components. For example, various software modules may be implemented for performing various functions in connection with the system of any particular aspect, and such modules may be implemented to run on server and/or client components.

FIGS. 3a-p illustrate example embodiments of streaming media application screens according to the present invention. FIG. 3a shows an initial screen 301 encountered by a potential buyer using the Realty Stars TV application 100 on a streaming media device 101. The potential buyer is shown a displayed code 321 that is entered into and input page 302 of the referring agent's website 115b as shown in FIG. 2b. The user uses a computing device 103 to access the referring agent's website 115b to enter the code. The referring agent's website 115b provides the entered code to the streaming media server 115 to connect the referring agent's television channel 115a to the Realty Stars TV application 100 on the user's streaming media device.

When the user first visits the referring agent's website 115b and is presented with a webpage as shown in FIG. 3b, the user clicks on the television channel link 322 that causes the website 115b to present a window 323 to accept the code 321 provided to the user on their large screen television 105. The user may also be prompted to log into the streaming media server 115 as shown in FIG. 3c. The login window 303 accepts a user ID 324 and a password 325 that the user created when an account on the streaming media server 115 was previously created. The streaming media server 115 uses the user ID 324 and password 325 to authenticate the user before granting access to the referring agent's television channel 115a via the streaming media device 101. The login window 303 may also use other third-party ID and authentication mechanisms 326 such as ones available from Google™ and Facebook. Upon successful authentication and acceptance of the code 321, the streaming media server 115 initiates display of the referring agent's television channel 115b onto the user's large screen television 105 via the streaming media device.

FIG. 3d shows a home page 304 from the Realty Stars TV application 100 that may be viewed using a streaming media device 101. The start page 304 has a set of navigation controls 327a-d, a set of search buttons 328a-h, example property thumbnails 330a-n, and agent contact information 329. The set of navigation controls 327a-d provides buyers access to a home page 327a, a favorites page of saved property listings 327b, menu, and other controls 327c-d.

The set of search buttons 328a-h provides a buyer with access to search results of a plurality of streaming media property descriptions 331a-n and related multimedia data using the Realty Stars TV application 100 on a streaming media device 101 as shown in FIG. 3e. The search button 328a provides a mechanism for a buyer to enter search query parameters used to define a desired search. These parameters include location by zip code, address, city or town, and state. Other search buttons 328b-h provide a plurality of predefined search queries, such as ones defined by towns and counties, that allows buyers to browse a plurality of streaming media property descriptions 330a-n from these predefined areas.

The example property thumbnails 330a-n provide images associated with the plurality of streaming media property descriptions 331a-n and related multimedia data that are generated in response to search queries. Each thumbnail 330a-n also acts as a hyperlink to the multimedia data for a specified property on the real estate television channel. The example property thumbnails 330a-n are typically presented as a scrollable list of available properties that may be viewed using the Realty Stars TV application 100 on the streaming media device 101.

The agent contact information 329 provides information to buyers to permit the contact of a real estate agent to inquire about one or more plurality of streaming media property descriptions 331a-n. The agent contact information 329 may include hyperlinks to send messages and establish calls to the agents using various communication tools such as Skype, Zoom, T-Mobile Digits, and other voice-over-IP communications applications.

FIG. 3e shows a search results page 305 that is provided from either a search query entered using the search button 328a or any of the plurality of browsing areas 328b-h. The search results page 305 includes a set of search results filters containing a set of property thumbnails 331a-f. The results presented on this page 305 may include a scrollable display of as many properties found that satisfy the search or browse query. Clicking on a thumbnail 331a-f will cause a multimedia presentation of the property listing to be played for the potential buyers on a streaming media device 101.

The set of search results filters 332a-h provide settings for various property characteristics such as for sale/rent, property type, location, property build date, number of bedrooms and baths, property square footage, and a minimum and maximum asking price. The buyer may set these filter values either in the initial search query or to further narrow a set of search results as the buyer focuses on a desired property and location. Each of these filter characteristics used by the search may be altered using the buttons for each filter 332a-h. FIGS. 3m-1 below disclose example setting of particular filter values.

Other information may be presented onto the search results page 303 including agent contact information 329 and a map (not shown) providing locations of the properties included in the set of search results.

FIG. 3f shows a property listing page 306 that includes a photo of the property 333, a listing of the price and address 334, and a watch listing button 335 that begins the multimedia data stream from the streaming media web server 115 to the streaming media device 101. The user may download a document containing relevant information related to the property using a download button 334. The document may contain images, text, hyperlinks, and other data useful to a potential buyer. The document may be provided in a PDF file format or other document file formats as desired.

The streaming media web server 115 may present a default rendering of the listing that includes a summary of the property in text form and a slide show of available photographs for the property. Listings from other agents typically may be presented in this format. Agents using the Realty Stars TV application 100 to create their own channel may create a more sophisticated multimedia presentation to present their listings in the best possible light. Additionally, the streaming media server 115 may also integrate other web-based services to enhance the watching experience for the users while simplifying the use of the application by providing access to the services simultaneously with the Realty Stars application 100. FIG. 3f shows integration of a music service 337 to add auditory background music to the television images. The integrated music services can include music from providers including iHeart Radio™, SiriusXM™, Spotify™, Apple Music™, Amazon Prime Music™ and the like. Integration of iHeart Radio™ is shown as the music service 337 in the example of FIG. 3f.

FIG. 3g shows a screen image 307 presenting a text description 337 of a particular property. A set of property search characteristics 338 are also included for review. FIG. 3h shows a map 308 showing a location 339 of the particular property.

FIG. 3i shows an agent contact page 309 that may be presented within the multimedia presentations of properties as well as from buttons found on many of the pages that typically are presented as agent contact information 341 as may be found on the search results page 304 or on the property listings page 306. This agent contact page 309 may include control buttons 351 to use this agent's contact information 342 to contact the agent as shown in FIG. 3j below and to save the property channel information 343 as a favorite for later retrieval.

FIG. 3j shows a message input page 310 that permits the user to create a message 344 using an on-screen keyboard 345 to then sent 347 to the agent. The message 344 will include reference to the particular property that is of interest to the user as well as contact information from the user that is associated with the user account accessed as shown above in reference to FIG. 3c. FIG. 3k shows a user sending information regarding the particular property to another individual using an email address 248 or a mobile number 349 to send an SMS text message. These messages may include a hyperlink to the property on the referring agent's website 115b as well as the downloadable document discussed above in reference to FIG. 3f.

FIG. 3l-m shown screens permitting the user to specify property parameters to be used to perform and filter a set of search results for a given geographic area. FIG. 3l shows a select property type window 313 that allows a user to select and cancel selection of a particular property type 352 to be used to present a set of search results. The user may select one or more property types 353 and indicate it is ok 354 to include the property type 352 in the list of used property types. Similarly, FIG. 3m shows a year-built screen 314 that allows the user to select a specified date range 356 for select 357 from a set of data ranges offered by the year-built screen 314.

FIG. 3n shows a favorite properties page 315 that contains thumbnail images 362-363 for any properties identified as a favorite using the favorite button 343 of FIG. 3i above. The user reaches the favorite properties page 315 using the favorites menu button 327b that is available on the home page 304 and various pages of the referring agent television channel 115a. A user selects of one of thumbnail images 362-363 returns the user to the property screens of FIGS. 3f-i for the selected property with the View property button 364. The user may see the property location on a map as shown in FIG. 3h with the View on Map button 365.

FIG. 3o shows a connected MLS channels list page 316 that presents a list of available referring agent channels that have been accessed and are available for the user to search for properties. Each of these channels are typically for different geographic areas as MLS systems for these different locales are not the same. Each of these channels operate in a manner shown herein with possible changes in branding associated with a particular referring agent 107.

FIG. 3p shows an integrated music service page 317. The user may access the integrated music service page 317 using the iHeartRadio button 327c that is available on the Home page of FIG. 3d 304 and various other pages. The user selects one of the available streaming music channels 367 that are offered by the particular integrated music service to have the streaming media of the integrated channel to played while the user is viewing the Realty Stars TV application 100. As noted above, the presentation of iHeart Radio service is offered in a preferred embodiment but one skilled in the art recognizes that one or more of the other available services may also be included using a similar integrated music service page 317.

FIG. 4 illustrates an example embodiment of a web page for a system providing searchable real estate listings and locations using streaming media according to the present invention. FIG. 4 shows a web page 401 for one particular agent that has links to the television channel presented on the streaming media device 101 using multimedia data streamed from the streaming media web server 115.

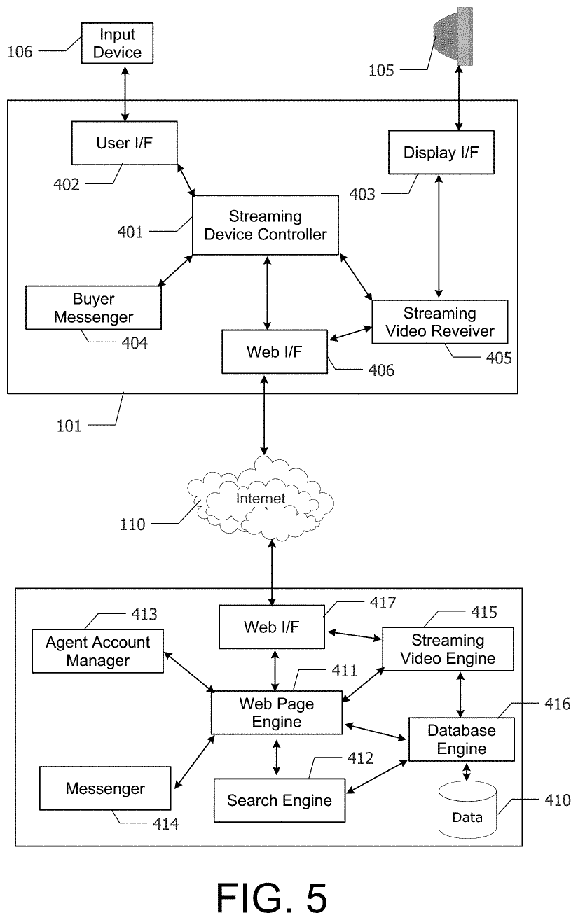

FIG. 5 illustrates a computing system of software components of a system providing searchable real estate listings and locations using streaming media according to the present invention. The Realty Stars TV application 100 uses a streaming media device 101 communicatively connected to the streaming media web server 115 over the Internet 110. The streaming media device 101 contains a set of software components 501-506 that perform functions disclosed herein.

The set of software components 501-506 within the streaming media device 101 comprises a streaming device controller 501, a user interface 502, a display interface 503, a buyer messenger 504, a streaming media receiver 505, and a web interface 506. The streaming device controller 501 acts as a central overall controller for the set of software components 502-506. User commands from the user interface 502 are received and processed to determine actions to be taken, and then mobile app commands are passed to the other software components 502-506, as needed, to implement the actions to be taken. The mobile app controller 501 also works with the user account manager 513 to determine whether or not a particular user of the Realty Stars TV application 100 at any particular point in time is authorized to access particular data entries within the database 510 and to take particular actions that may be requested. As such, different user accounts may be authorized to perform an individual user set of tasks associated with each user and to access a particular subset of data. The streaming device controller 50 is responsible for enforcing these security privileges.

The user interface 502 provides input and output processing to provide a buyer with messages and data needed to perform property search and display functions. This user interface 502 also accepts commands from the buyer using the input device 106 to instruct the Realty Stars TV application 100 to perform these tasks.

The display interface 403 provides output processing to provide a buyer with streaming media data from the streaming media web server 115 and other user pages as shown in FIGS. 4a-f onto the attached display device 105.

The buyer messenger 504 provides buyers with a mechanism to send and receive messages with the real estate agent computing system 102. The buyer messenger 504 sends the message data to a messenger 514 within the streaming media web server 115 which is ultimately forwarded to the real estate agent computing system 102. The buyer messenger 404 may also receive responsive messages from the messenger 514 within the streaming media web server 115 that has been sent from the real estate agent computing system 102.

The streaming media receiver 505 sets up and uses a streaming media data connection with the streaming media web server 115 to obtain streaming media for output onto the display device 106 through the display interface 503. The streaming media receiver 505 provides any device driver and related data formatting operations to render the streaming media data from the streaming media web server 115 in a resolution and format supported by the display device 105.

The web interface 506 permits the streaming media device 101 to communicate with the streaming media web server 115. The web interface 506 performs all of the data formatting, computer-to-computer communications, encryption processing, and all similar operations needed by the web server to communicate with users.

The set of software components 511-517 within the streaming media web server 115 comprises a TV channel engine 511, a search engine 512, a user account manager 513, a messenger 514, a streaming media engine 515, a database engine 516 coupled to local data storage 510, and a web interface 517. The TV channel engine 511 controls the overall operation of the streaming media web server 115 as it permits buyers to obtain search results and a plurality of streaming media property descriptions 116a-n with their related multimedia data. The TV channel engine 511 uses the user account manager 513 to authenticate users to provide access to the streaming media web server 115 to obtain the plurality of streaming media property descriptions 116a-n and related multimedia data. The TV channel engine 511 uses the streaming media engine 515 to set up and service a streaming media television channel with a streaming media receiver 505 within the streaming media device 101.

The search engine 512 generates the search results for available streaming media property descriptions 116a-n and related multimedia data within the database 510 based upon a query or browse request from the Realty Stars TV application 100. The query or browse request includes search terms, category names, and mobile application location data that are used by the search engine 512. The generated search results are returned to the Realty Stars TV application 100 via the web interface 517.

The user account manager 513 permits users to connect to and access the streaming media web server 115. The user account manager 513 is responsible for creating and managing user accounts for the real estate agent computing system 102 and the buyer's streaming media device 101. The user account manager 513 also is used in authenticating a user based upon user input. Typically, the real estate agent computing system 102 input uses a username and password. Multi-factor authentication, use of one-time passwords, and similar secure authentication mechanisms may be included in the user profile. Buyers connect to the streaming media web server 115 using the access codes 321 as shown in FIG. 3a. For every sign in the system will recognize the user type, i.e. buyer streaming media device 101 and real estate agent computing system 102, along with all past activities from account details in the database. Based on user type, the streaming media web server 115 behavior will change.

The messenger 514 provides buyers and agents with a mechanism to send and receive messages with each other. The messenger 514 receives the message data from the buyer messenger 504 within the streaming media device 101 which is ultimately forwarded to the real estate agent computing system 102. The messenger 514 may also receive responsive messages from the real estate agent computing system 102 that are forwarded to the streaming media device 101 once the buyer logs into the streaming media web server 115 again using the streaming media device 101.

The streaming media engine 515 establishes a direct data connection with the streaming media receiver 505 within the streaming media device 101 over the Internet 110 to provide multimedia data associated with the plurality of streaming media property descriptions 116a-n. The streaming media engine 515 sends data to the streaming media receiver 505 within the streaming media device 101 to provide a constant stream of multimedia data as needed to provide a television channel of the Realty Stars TV application 100 to buyers.

The database engine 516 coupled to local data storage 510 processes all database operations related to the streaming media data for the streaming media web server 115. These operations include insertion of the plurality of streaming media property descriptions 116a-n and related multimedia data into the database 510, deletion of the plurality of streaming media property descriptions 116a-n and related multimedia data from the database 510, searching and retrieving the plurality of streaming media property descriptions 116a-n and related multimedia data from the database 510, and indexing the database 510 to maintain efficient searching when needed.

The web interface 517 permits the streaming media web server 115 to communicate with one or more streaming media devices 101. The web interface 517 performs all of the data formatting, computer-to-computer communications, encryption processing, and all similar operations needed by the web server to communicate with users.

The real estate agent computing system (not shown) uses a web browser to log into the streaming media web server 115 to create a plurality of streaming media property descriptions 116a-n and upload streaming media data associated with these property listings. The plurality of streaming media property descriptions 116a-n and upload streaming media data associated with these property listings may be created using standard web creation tools.

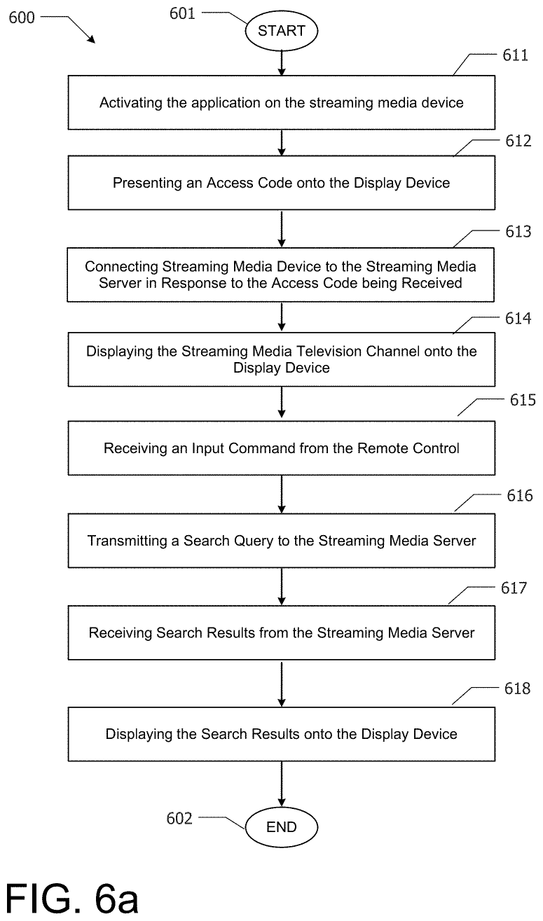

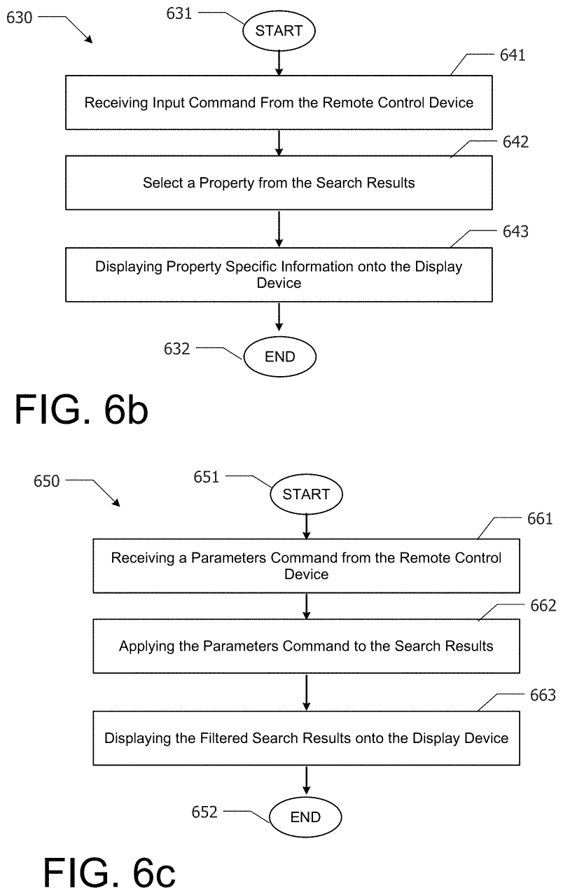

FIGS. 6a-c illustrate a flowchart corresponding to a method performed by software components of a system providing a searchable real estate listing and location using streaming media according to the present invention. FIG. 6a shows the initial sequence of steps in the method. The process 600 begins 601 when in step 611 the streaming media device 101 activates an application on the streaming media device 101 in response to a first input command from the remote-control device 102. The streaming media device 101, in step 612, presents an access code 321 on the display device 105. In response to receiving the access code 321 by the web server 115 entered into a web page 115b associated with the streaming media television channel for real estate searches 115a, step 613 connects the streaming media device 101 to the streaming media server 115 to receive the streaming media television channel for real estate searches 115a. In step 614, the streaming media device 101 displays the streaming media television channel for real estate searches 115a onto the display device 105.

The streaming media device 101 receives a second input command from the remote-control device 102 in step 615 and transmits a search query for available properties to the streaming media server 115 in response to the second input command in step 616. In step 617, the streaming media device 101 receives search results in response to the search query from the streaming media device 101, the search results are contained within streaming media data containing streaming video and streaming audio data and displays the search results onto the display device 105 in step 618 before the process 600 ends 602.

FIG. 6b shows a flowchart of operations of the streaming media device 101 to select a particular property for display. The process 630 begins 631 when in step 641 the streaming media device 101 receives an input command from the remote-control device 102. In step 642, the streaming media device 101 selects a particular property in response to the input command. Property specific information is displayed onto the display device 105 by the streaming media device 101 in step 643 before process 630 ends 632.

FIG. 6c shows a flowchart of operations of the streaming media device 101 to specify search parameters to be applied to filter the search results received from the streaming media server 115 and displayed by the streaming media device 101 onto the display device 105. The process 650 begins 651 when a parameters command is received by the streaming media device 101 from the 105 that defines one of the one or more search parameters in step 661. The streaming media device 101, in step 662, applies the one of the one or more search parameters to the search results to generate filtered search results. The filtered search results are displayed onto the display device 105 by the streaming media device 101 in step 663 and the process 650 ends 652.

The embodiments described herein are implemented as logical operations performed by a computer. The logical operations of these various embodiments of the present invention are implemented (1) as a sequence of computer-implemented steps or program modules running on a computing system and/or (2) as interconnected machine modules or hardware logic within the computing system. The implementation is a matter of choice dependent on the performance requirements of the computing system implementing the invention. Accordingly, the logical operations making up the embodiments of the invention described herein can be variously referred to as operations, steps, or modules.

Even though particular combinations of features are recited in the present application, these combinations are not intended to limit the disclosure of the invention. In fact, many of these features may be combined in ways not specifically recited in this application. In other words, any of the features mentioned in this application may be included to this new invention in any combination or combinations to allow the functionality required for the desired operations.

No element, act, or instruction used in the present application should be construed as critical or essential to the invention unless explicitly described as such. Further, the phrase “based on” is intended to mean “based, at least in part, on” unless explicitly stated otherwise. Any singular term used in this present patent application is applicable to its plural form even if the singular form of any term is used.

In the present application, all or any part of the invention's software or application(s) or smart device application(s) may be installed on any of the user's or operator's smart device(s), any server(s) or computer system(s) or web application(s) required to allow communication, control (including but not limited to control of parameters, settings such as for example, sign copy brightness, contrast, ambient light sensor settings . . . etc.), transfer of content(s) or data between any combination of the components.

What is claimed is:

1. A streaming media device for providing a streaming media television channel for real estate searches onto a display device, the streaming media device configured to communicatively interconnect the streaming media device, a streaming media server, and a web server over the Internet, the streaming media device comprising:
a remote-control device for receiving input commands from a user;
a memory having instructions stored thereon; and
a processor configured to execute the instructions on the memory to cause the streaming media device to:
activate an application on the streaming media device in response to a first input command from the remote-control device;
present an access code on the display device;
in response to receiving the access code by the web server entered into a web page associated with the streaming media television channel for real estate searches, connect the streaming media device to the streaming media server to receive the streaming media television channel for real estate searches;
display the streaming media television channel for real estate searches onto the display device;
receive a second input command from the remote control device;
transmit a search query for available properties to the streaming media server in response to the second input command;
receive search results in response to the search query from the streaming media device, the search results are contained within streaming media data containing streaming video and streaming audio data; and
display the search results onto the display device.

2. The streaming media device according to claim 1, wherein the processor is further configured to execute additional instructions to cause the streaming media device to:
receive a third input command from the remote control device;
select a property contained within the search results and display property specific information onto the display device, the property specific information comprises:
textual description of the property;
one or more images of the property; and
a message link that sends a prospective buyer message to a real estate agent associated with the streaming media television channel for real estate searches expressing interest in the property in response to a message input command received from the remote-control device activating the message link; and
display the property specific information onto the display device.

3. The streaming media device according to claim 2, wherein the property specific information further comprises:
streaming video data of the property;
a favorites link that saves an identifier associated with the property to a list of favorite properties associated with a user of the streaming media device in response to a favorites input command received from the remote-control device activating the favorites link; and
a map image showing a location of the property.

4. The streaming media device according to claim 2, wherein the property specific information further comprises:
a forwards link that sends an information message containing a hyperlink associated with the property within a real estate multiple listing service to a specified individual in response to a favorites input command received from the remote control device activating the favorites link, the information message is sent as a message comprising one of the following: an email and an SMS text message.

5. The streaming media device according to claim 1, wherein the processor is further configured to execute additional instructions to cause the streaming media device to:
receive a parameters input command from the streaming media device, the parameters input command specifies one or more search filter parameters applicable to the property;
apply the parameters input command to the search results to create filtered search results; and
display the filtered search results onto the display device.

6. The streaming media device according to claim 5, wherein the one or more search filter parameters comprise property type, year built, number of bedrooms, number of bathrooms, minimum square footage, minimum asking price, and maximum asking price.

7. The streaming media device according to claim 4, wherein contents of the prospective buyer message and the information message are entered by the user using a keyboard displayed on the display device, the contents of the message the prospective buyer message and the information message are specified in a sequence of input character commands received by the streaming media device from the remote-control device selecting characters from the keyboard.

8. A method for providing a streaming media television channel for real estate searches onto a display device by a streaming media device, the streaming media device configured to communicatively interconnect the streaming media device, a streaming media server, and a web server over the Internet, the streaming media device comprises a remote-control device for receiving input commands from a user, a memory having instructions stored thereon, and a processor configured to execute the instructions on the memory, the method comprising:
activating an application on the streaming media device in response to a first input command from the remote-control device;
presenting an access code on the display device;
in response to receiving the access code by the web server entered into a web page associated with the streaming media television channel for real estate searches, connecting the streaming media device to the streaming media server to receive the streaming media television channel for real estate searches;
displaying the streaming media television channel for real estate searches onto the display device;
receiving a second input command from the remote control device;
transmitting a search query for available properties to the streaming media server in response to the second input command;
receiving search results in response to the search query from the streaming media device, the search results are contained within streaming media data containing streaming video and streaming audio data; and
displaying the search results onto the display device.

9. The method according to claim 8, wherein the method further comprising:
receiving a third input command from the remote control device;
selecting a property contained within the search results and display property specific information onto the display device, the property specific information comprises:
textual description of the property;
one or more images of the property; and
a message link that sends a prospective buyer message to a real estate agent associated with the streaming media television channel for real estate searches expressing interest in the property in response to a message input command received from the remote-control device activating the message link; and
displaying the property specific information onto the display device.

10. The method according to claim 9, wherein the property specific information further comprises:
streaming video data of the property;
a favorites link that saves an identifier associated with the property to a list of favorite properties associated with a user of the streaming media device in response to a favorites input command received from the remote control device activating the favorites link; and
a map image showing a location of the property.

11. The method according to claim 9, wherein the property specific information further comprises:
a forwards link that sends an information message containing a hyperlink associated with the property within a real estate multiple listing service to a specified individual in response to a favorites input command received from the remote control device activating the favorites link, the information message is sent as a message comprising one of the following: an email and an SMS text message.

12. The method according to claim 8, wherein the method further comprising:
receiving a parameters input command from the streaming media device, the parameters input command specifies one or more search filter parameters applicable to the property;
applying the parameters input command to the search results to create filtered search results; and
displaying the filtered search results onto the display device.

13. The method vice according to claim 11, wherein the one or more search filter parameters comprise property type, year built, number of bedrooms, number of bathrooms, minimum square footage, minimum asking price, and maximum asking price.

14. The method according to claim 11, wherein contents of the prospective buyer message and the information message are entered by the user using a keyboard displayed on the display device, the contents of the message the prospective buyer message and the information message are specified in a sequence of input character commands received by the streaming media device from the remote-control device selecting characters from the keyboard.

15. A non-transitory computer-readable recording medium in a streaming media device for providing a streaming media television channel for real estate searches onto a display device, the streaming media device configured to communicatively interconnect the streaming media device, a streaming media server, and a web server over the Internet, the streaming media device comprises a remote-control device for receiving input commands from a user, a memory having instructions stored thereon; and a processor configured to execute the instructions on the memory the streaming media device, the non-transitory computer-readable recording medium storing one or more programs which when executed by the processor of the streaming media device performs steps comprising activating an application on the streaming media device in response to a first input command from the remote-control device;
presenting an access code on the display device;
in response to receiving the access code by the web server entered into a web page associated with the streaming media television channel for real estate searches, connecting the streaming media device to the streaming media server to receive the streaming media television channel for real estate searches;
displaying the streaming media television channel for real estate searches onto the display device;
receiving a second input command from the remote control device;
transmitting a search query for available properties to the streaming media server in response to the second input command;
receiving search results in response to the search query from the streaming media device, the search results are contained within streaming media data containing streaming video and streaming audio data;
displaying the search results onto the display device;
receiving a third input command from the remote control device;
selecting a property contained within the search results and display property specific information onto the display device, the property specific information comprises:
textual description of the property;
one or more images of the property; and
a message link that sends a prospective buyer message to a real estate agent associated with the streaming media television channel for real estate searches expressing interest in the property in response to a message input command received from the remote-control device causing the activation the message link; and
displaying the property specific information onto the display device.

16. The non-transitory computer-readable recording medium according to claim 15, wherein the property specific information further comprises:
streaming video data of the property;
a favorites link that saves an identifier associated with the property to a list of favorite properties associated with a user of the streaming media device in response to a favorites input command received from the remote control device activating the favorites link; and
a map image showing a location of the property.

17. The non-transitory computer-readable recording medium according to claim 16, wherein the property specific information further comprises:
a forwards link that sends an information message containing a hyperlink associated with the property within a real estate multiple listing service to a specified individual in response to a favorites input command received from the remote control device activating the favorites link, the information message is sent as a message comprising one of the following: an email and an SMS text message.

18. The non-transitory computer-readable recording medium according to claim 15, wherein the method further comprising:
receiving a parameters input command from the streaming media device, the parameters input command specifies one or more search filter parameters applicable to the property;
applying the parameters input command to the search results to create filtered search results; and
displaying the filtered search results onto the display device.

19. The non-transitory computer-readable recording medium vice according to claim 17, wherein the one or more search filter parameters comprise property type, year built, number of bedrooms, number of bathrooms, minimum square footage, minimum asking price, and maximum asking price.

20. The non-transitory computer-readable recording medium according to claim 17, wherein contents of the prospective buyer message and the information message are entered by the user using a keyboard displayed on the display device, the contents of the message the prospective buyer message and the information message are specified in a sequence of input character commands received by the streaming media device from the remote-control device selecting characters from the keyboard.
